(19) United States
(12) Patent Application Publication
(10) Pub. No.: US 2023/0291018 A1
(43) Pub. Date: Sep. 14, 2023

(54) CHARGE AND DISCHARGE CONTROL CIRCUIT AND BATTERY DEVICE INCLUDING THE SAME

(71) Applicant: ABLIC Inc., Tokyo (JP)

(72) Inventors: Sho HOSHINO, Tokyo (JP); Takashi ONO, Tokyo (JP)

(73) Assignee: ABLIC Inc., Tokyo (JP)

(21) Appl. No.: 18/090,463

(22) Filed: Dec. 28, 2022

(30) Foreign Application Priority Data
Mar. 8, 2022 (JP) 2022-034910

(51) Int. Cl. H01M 10/44; H01M 10/42; H01M 10/46

(52) U.S. Cl. CPC H01M 10/44; H01M 10/425; H01M 10/46; H01M 2010/4271

(57) ABSTRACT

A charge and discharge control circuit includes an external terminal voltage input port, a positive electrode power supply terminal, a negative electrode power supply terminal, a detector and an external terminal voltage detector connected to the external terminal voltage input port, and a control circuit. The external terminal voltage input port is connected to an external terminal via an external resistor. The positive electrode power supply terminal and the negative electrode power supply terminal are respectively connected to positive and negative electrodes of a secondary cell. The detector outputs a power-down detection signal to the control circuit in a case where the external terminal voltage input port receives a power-down control signal according to turn-on of an external FET, and outputs a power-down release signal to the control circuit in a case where the external FET is turned off and a charger is connected to the external terminal.

### CROSS-REFERENCE TO RELATED APPLICATION

This application claims the priority benefit of Japan application serial no. 2022-034910, filed on Mar. 8, 2022. The entirety of the above-mentioned patent application is hereby incorporated by reference herein and made a part of this specification.

### BACKGROUND

### Technical Field

The present invention relates to a charge and discharge control circuit and a battery device including the same.

### Related Art

To prevent unnecessary discharge of a secondary cell at the time of shipment of a battery device, a charge and discharge control circuit is also provided with a function of forcibly transitioning to a power-down state.

FIG. 3 is a block diagram illustrating a conventional charge and discharge control circuit and a battery device including the same. The conventional battery device includes a secondary cell SC, a charge and discharge control circuit 51 connected to the secondary cell SC, a discharge control FET 52, a charge control FET 53, a controller 54 capable of outputting a signal of transitioning to the power-down state to the charge and discharge control circuit 51, resistors 55 and 56, a capacitor 57, an external positive electrode terminal EB+, and an external negative electrode terminal EB−. A load is connected between the external positive electrode terminal EB+ and the external negative electrode terminal EB−.

The charge and discharge control circuit 51 includes a charge and discharge monitoring circuit 511, a control circuit 512, a detector 513, switches 514 and 515, a positive electrode power supply terminal VDD, a negative electrode power supply terminal VSS, a discharge control terminal DO, a charge control terminal CO, an external terminal voltage input port VM, and a control signal input port CTL.

In the conventional battery device 50, in the case where the controller 54 outputs a power-down control signal to the control signal input port CTL, the discharge path to the load, the controller 54, the charge and discharge monitoring circuit 511, and the detector 513 may be disconnected to transition to a power-down state in which current consumption is reduced.

However, since the charge and discharge control circuit described above is provided with a dedicated control signal input port CTL for receiving a signal for transitioning to the power-down state, there is a problem that the chip size and the number of pins of the package increase and the cost increases.

### SUMMARY

A charge and discharge control circuit according to an aspect of the present invention is a charge and discharge control circuit provided with a power-down function and includes an external terminal voltage input port, a positive electrode power supply terminal, a negative electrode power supply terminal, a detector, an external terminal voltage detector, and a control circuit. The external terminal voltage input port is connected to an external terminal via an external resistor. The positive electrode power supply terminal is connected to a positive electrode of a secondary cell. The negative electrode power supply terminal is connected to a negative electrode of the secondary cell. The detector and the external terminal voltage detector are connected to the external terminal voltage input port. The detector outputs a power-down detection signal to the control circuit in a case where the external terminal voltage input port receives a power-down control signal according to turn-on of an external FET, and outputs a power-down release signal to the control circuit in a case where the external FET is turned off and a charger is connected to the external terminal.

According to the charge and discharge control circuit of the present invention, it is possible to provide a charge and discharge control circuit having a function of forcibly transitioning to a power-down state without providing a dedicated control signal input port.

### BRIEF DESCRIPTION OF THE DRAWINGS

FIG. 1 is a block diagram illustrating a charge and discharge control circuit according to the present embodiment and a battery device including the same.

FIG. 2 is a circuit diagram illustrating a detector and a VM detector according to the present embodiment.

FIG. 3 is a block diagram illustrating a conventional charge and discharge control circuit and a battery device including the same.

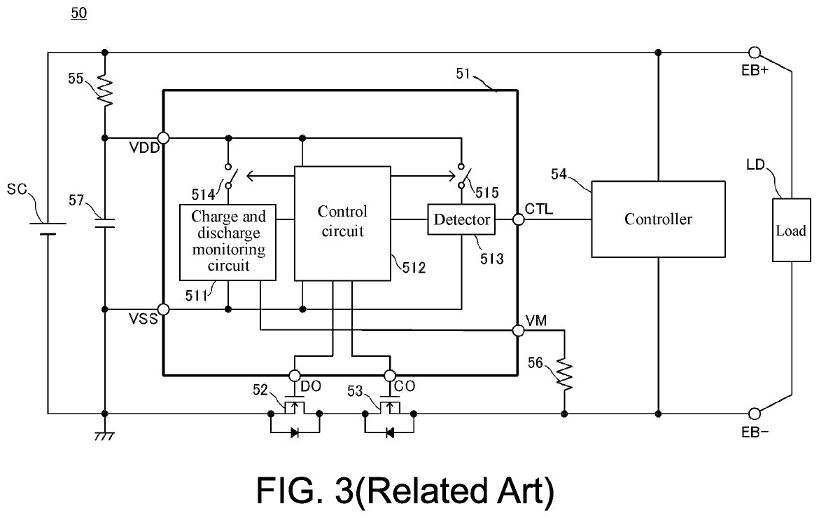

### DESCRIPTION OF THE EMBODIMENTS

The embodiment of the present invention provides a charge and discharge control circuit having a function of forcibly transitioning to a power-down state without providing a dedicated control signal input port.

Hereinafter, an embodiment of the present invention will be described with reference to the drawings.

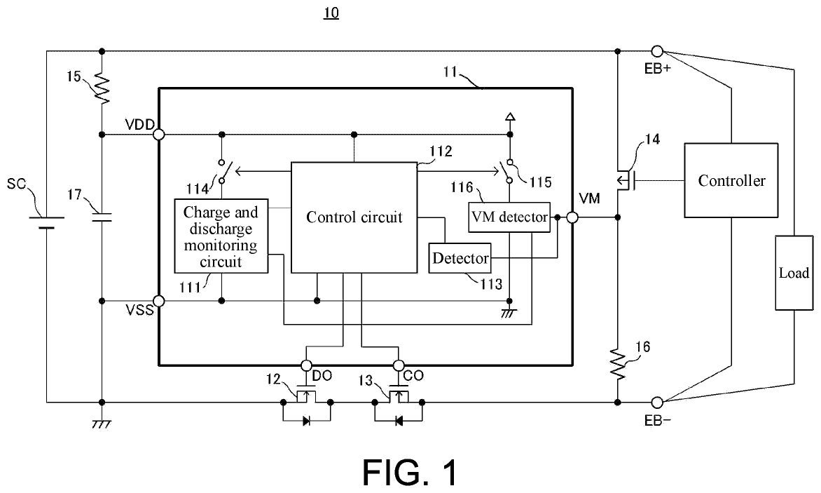

FIG. 1 is a block diagram illustrating a charge and discharge control circuit according to the present embodiment and a battery device including the same. A battery device 10 of the present embodiment includes a secondary cell SC, a charge and discharge control circuit 11, a discharge control FET 12, a charge control FET 13, an FET 14, resistors 15 and 16, a capacitor 17, an external positive electrode terminal EB+, and an external negative electrode terminal EB−. The external positive electrode terminal EB+ and the external negative electrode terminal EB− may be collectively referred to as an external terminal. A controller capable of outputting a control signal for forced power-down, a load, a charger, etc. are connected to the external terminal.

The charge and discharge control circuit 11 includes a charge and discharge monitoring circuit 111, a control circuit 112, a detector 113, switches 114 and 115, a VM detector 116 (also referred to as an external terminal voltage detector), a positive electrode power supply terminal VDD, a negative electrode power supply terminal VSS, a discharge control terminal DO, a charge control terminal CO, and an external terminal voltage input port VM.

The positive electrode power supply terminal VDD is connected to a positive electrode of the secondary cell SC and the external positive electrode terminal EB+ via the resistor 15. The negative electrode power supply terminal VSS is connected to a negative electrode of the secondary cell SC and a ground potential.

The charge and discharge monitoring circuit 111, the control circuit 112, the detector 113, and the VM detector 116 are connected in parallel between the positive electrode power supply terminal VDD and the negative electrode power supply terminal VSS. That is, the charge and discharge monitoring circuit 111, the control circuit 112, the detector 113, and the VM detector 116 are applied with a VDD-VSS voltage as an operating voltage. Among these components, the charge and discharge monitoring circuit 111 and the VM detector 116 are applied with the VDD-VSS voltage via the switches 114 and 115 capable of being controlled to turn on and off by the control circuit 112. The switches 114 and 115 are switched from on to off in the case of transitioning from a normal state to a power-down state, and are switched from off to on in the case of transitioning from the power-down state to the normal state.

Herein, the “power-down state” refers to a state in which the discharge path of the secondary cell SC is disconnected, and the operations of the charge and discharge monitoring circuit 111 and the VM detector 116 are stopped by the switches 114 and 115 to reduce current consumption.

The charge and discharge monitoring circuit 111 outputs an overcharge detection signal to the control circuit 112 upon detecting overcharge of the secondary cell SC, and outputs an overdischarge detection signal to the control circuit 112 upon detecting overdischarge of the secondary cell SC.

The external terminal voltage input port VM is a terminal for detecting the voltage of the external negative electrode terminal EB− and is connected to the external negative electrode terminal EB− via the resistor 16. Further, the external terminal voltage input port VM also serves as a terminal receiving a power-down control signal from the FET 14. The FET 14 includes a gate connected to an output port of the controller, a source connected to the external positive electrode terminal EB+, and a drain connected to the external terminal voltage input port VM.

The detector 113 detects the power-down control signal received by the external terminal voltage input port VM. The power-down control signal is, for example, the EB+ terminal voltage set by turning on the FET 14 according to the control signal of the controller. Upon detecting the power-down control signal, the detector 113 outputs a power-down detection signal to the control circuit 112. Further, the detector 113 detects that a charger is connected to the external terminal according to a drop in the voltage of the external terminal voltage input port VM to the voltage of the negative electrode power supply terminal VSS. Upon detecting that the charger is connected to the external terminal, the detector 113 outputs a power-down release signal to the control circuit 112.

The VM detector 116 determines whether a load or charger is connected to the external terminal. In the normal state, the discharge control FET 12 and the charge control FET 13 are turned on, so the voltage of the external terminal voltage input port VM is close to the voltage of the negative electrode power supply terminal VSS. The potential of the external terminal voltage input port VM (based on the ground terminal voltage VSS) in the normal state is Idis×Rin in the case where a load is connected and a discharge current is flowing, and is −Ichg×Rin in the case where a charger is connected and a charge current is flowing. Herein, Idis is the discharge current value, Ichg is the charge current value, and Rin is a sum of the resistance values in the case where the discharge control FET 12 and the charge control FET 13 are turned on. For example, if the potential of the external terminal voltage input port VM is negative, the VM detector 116 determines that a charger is connected to the external terminal, and outputs an L-level charger detection signal to the charge and discharge monitoring circuit 111.

The control circuit 112 turns on and off the discharge control FET 12 and the charge control FET 13 based on the signal from the charge and discharge monitoring circuit 111 to control charge and discharge of the secondary cell SC. The control circuit 112 outputs an H-level charge permission signal permitting charge to the charge control terminal CO to turn on the charge control FET 13 in the case of permitting charge of the secondary cell SC, and outputs an L-level charge prohibition signal prohibiting charge to the charge control terminal CO to turn off the charge control FET 13 in the case of prohibiting charge of the secondary cell SC. Further, the control circuit 112 outputs an H-level discharge permission signal permitting discharge to the discharge control terminal DO to turn on the discharge control FET 12 in the case of permitting discharge of the secondary cell SC, and outputs an L-level discharge prohibition signal prohibiting discharge to the discharge control terminal DO to turn off the discharge control FET 12 in the case of prohibiting discharge of the secondary cell SC.

Upon receiving a power-down detection signal from the detector 113, the control circuit 112 outputs the L-level discharge prohibition signal prohibiting discharge to the discharge control terminal DO to turn off the discharge control FET 12. Further, upon receiving a power-down release signal from the detector 113, the control circuit 112 outputs the H-level discharge permission signal permitting discharge to the discharge control terminal DO to turn on the discharge control FET 12.

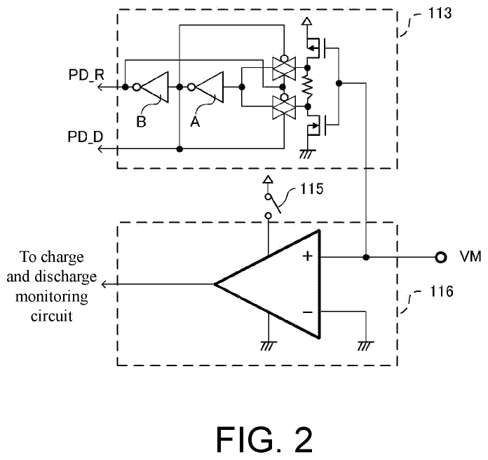

FIG. 2 is a circuit diagram illustrating an example of the detector 113 and the VM detector 116 of the present embodiment. The detector 113 is composed of, for example, a Schmitt trigger circuit. A power-down detection signal PD_D is outputted from an output port of an inverter A in the second stage, and a power-down release signal PD_R is outputted from an output port of an inverter B in the third stage.

Next, the operation of the battery device 10 in the case of transitioning from the normal state to the power-down state will be described with reference to FIG. 1 and FIG. 2. Herein, at the time of shipment of the product, with a load LD being connected between the external positive electrode terminal EB+ and the external negative electrode terminal EB−, the operation of the controller which controls the FET 14 to output a power-down control signal to switch the battery device 10 from the normal state to the power-down state will be described. The secondary cell SC is charged to a voltage which does not exceed an overcharge voltage. It is assumed that both the discharge control FET 12 and the charge control FET 13 are turned on.

The controller inputs an H-level power-down control signal to the external terminal voltage input port VM of the charge and discharge control circuit 11 via the FET 14. Upon receiving the H-level power-down control signal at the input port, the detector 113 outputs an H-level power-down detection signal PD_D from the output port of the inverter A. Upon receiving the H-level power-down detection signal PD_D, the control circuit 112 transitions to the power-down state. That is, the control circuit 112 turns off the discharge control FET 12 via the discharge control terminal DO to turn off the switches 114 and 115.

Upon transitioning to the power-down state, the discharge control FET 12 is turned off, and the external terminal voltage input port VM is pulled up to the H level by the load via the resistor 16. Thus, even if the controller does not continue to output the signal to turn off the FET 14, the charge and discharge control circuit 11 can maintain the power-down state. That is, even if the controller connected to the external terminal is cut off from the supply of the voltage of the secondary cell SC and becomes inoperable, the battery device 10 can maintain the power-down state.

Next, upon connection of a charger to the external terminal, the voltage of the external terminal voltage input port VM is lower than the ground terminal voltage VSS. The detector 113 detects that an L-level power-down control signal is received at the input port, and outputs an H-level power-down release signal PD_R from the output port of the inverter B. Upon receiving the H-level power-down release signal PD_R, the control circuit 112 releases the power-down state. That is, the control circuit 112 turns on the discharge control FET 12 via the discharge control terminal DO to turn on the switches 114 and 115.

As described above, in the battery device 10, the power-down detection signal PD_D and the power-down release signal PD_R are outputted by the detector 113, which detects the voltage of the external terminal voltage input port VM, to transition to and release the power down state.

As described above, the charge and discharge control circuit of the present embodiment is configured to input the power-down control signal according to the H-level signal of the FET controlled by the controller, so it becomes possible to use the external terminal voltage input port VM also as a control signal input port. Also, the detection circuit is composed of a Schmitt trigger circuit, so it has noise immunity and can output a power-down detection signal and a power-down release signal without requiring an additional circuit. Thus, in the charge and discharge control circuit of the present embodiment, the number of pins can be reduced without increasing the number of circuits, which makes it possible to reduce the cost of chips and packages.

Although the embodiment of the present invention has been described above, the present invention is not limited to the above embodiment, and various modifications may be made without departing from the scope of the present invention. For example, the logic of various signals described in the embodiment is not limited thereto. Thus, the output signal of the detector is not limited thereto, either. Further, for example, although it has been described that the controller controls the FET 14, the battery device may also include a control terminal connected to the gate of the FET 14 to input a control signal from the outside. Further, for example, although it has been described that the discharge control FET 12 and the charge control FET 13 are connected to the negative electrode side of the secondary cell SC, they may also be connected to the positive electrode side of the secondary cell SC. In that case, the external terminal voltage input port VM is connected to the external positive electrode terminal EB+ via a resistor. Further, for example, the controller may also be included in the battery device 10.

What is claimed is:

1. A charge and discharge control circuit provided with a power-down function, the charge and discharge control circuit comprising:
an external terminal voltage input port connected to an external terminal via an external resistor;
a detector and an external terminal voltage detector which are connected to the external terminal voltage input port; and
a control circuit,
wherein the detector outputs a power-down detection signal to the control circuit in a case where the external terminal voltage input port receives a power-down control signal according to turn-on of an external FET, and outputs a power-down release signal to the control circuit in a case where the external FET is turned off and a charger is connected to the external terminal.

2. The charge and discharge control circuit according to claim 1, wherein
the detector is composed of a Schmitt trigger circuit.

3. A battery device comprising:
a secondary cell;
a first external terminal connected to a first electrode of the secondary cell;
a charge and discharge control FET connected to a second electrode of the secondary cell;
a second external terminal connected to the charge and discharge control FET;
an FET and a resistor which are connected in series between the first external terminal and the second external terminal; and
the charge and discharge control circuit according to claim 1, comprising: a positive electrode power supply terminal connected to a positive electrode of the secondary cell; a negative electrode power supply terminal connected to a negative electrode of the secondary cell; the external terminal voltage input port connected to a connection point between the FET and the resistor; and a charge and discharge control terminal connected to the charge and discharge control FET.

4. The battery device according to claim 3, comprising a controller connected between the first external terminal and the second external terminal and controlling the FET.
